(19) United States
(12) Patent Application Publication
(10) Pub. No.: US 2018/0163630 A1
(43) Pub. Date: Jun. 14, 2018

(54) FUEL SUPPLY SYSTEM

(71) Applicant: ROLLS-ROYCE PLC, London (GB)

(72) Inventor: Daniel J. BICKLEY, Derbyshire (GB)

(73) Assignee: ROLLS-ROYCE PLC, London (GB)

(21) Appl. No.: 15/821,317

(22) Filed: Nov. 22, 2017

(30) Foreign Application Priority Data
Dec. 9, 2016 (GB) 1621005.6

(51) Int. Cl. F02C 7/228; F02C 9/34; F02C 9/26; F02C 7/232; F23R 3/34; F02C 7/22

(52) U.S. Cl. CPC F02C 7/228; F02C 9/34; F02C 9/263; F02C 7/232; F23R 3/346; F05D 2270/66; F05D 2220/323; F05D 2240/35; F05D 2270/64; F05D 2270/62; F02C 7/222

(57) ABSTRACT

A fuel supply system includes a metering and splitting arrangement receiving a fuel flow and controllably meters and splits the received fuel flow into metered pilot and mains flows for injecting at injector pilot and mains fuel discharge orifices to perform combustor staging control. The system includes mains isolation valves and a mains fuel distribution pipework has fuel lines connected to one of the orifices and extending therefrom to a respective one of the valves. Each valve has a closed position for removing the mains fuel from its injector through its line when the mains distribution pipework is deselected for pilot-only operation, and isolates its line from the metering and splitting arrangement. Each valve has an open position for refilling its injector with mains fuel through its line when the mains distribution pipework is selected for pilot and mains operation, and reconnects its line to the metering and splitting arrangement.

### FIELD OF THE INVENTION

The present invention relates to a fuel supply system for fuel injectors of a multi-stage combustor of a gas turbine engine.

### BACKGROUND

Multi-stage combustors are used particularly in lean burn fuel systems of gas turbine engines to reduce unwanted emissions while maintaining thermal efficiency and flame stability. For example, duplex fuel injectors have pilot and mains fuel manifolds feeding pilot and mains discharge orifices of the injectors. At low power conditions only the pilot stage is activated, while at higher power conditions both pilot and mains stages are activated. The fuel for the manifolds typically derives from a pumped and metered supply. A splitter valve can then be provided to selectively split the metered supply between the manifolds as required for a given staging.

A typical annular combustor has a circumferential arrangement of fuel injectors, each associated with respective pilot and mains feeds extending from the circumferentially extending pilot and mains manifolds. Each injector generally has a nozzle forming the discharge orifices which discharge fuel into the combustion chamber of the combustor, a feed arm for the transport of fuel to the nozzle, and a head at the outside of the combustor at which the pilot and mains feeds enter the feed arm. Within the injectors, a check valve, known as a flow scheduling valve (FSV), is typically associated with each feed in order to retain a primed manifold when de-staged and at shut-down. The FSVs also prevent fuel flow into the injector nozzle when the supply pressure is less than the cracking pressure (i.e. less than a given difference between manifold pressure and combustor gas pressure).

Multi-stage combustors may have further stages and/or manifolds. For example, the pilot manifold may be split into two manifolds for lean blow-out prevention during rapid engine decelerations.

During pilot-only operation, the splitter valve directs fuel for burner flow only through the pilot fuel circuit (i.e. pilot manifold and feeds). It is therefore conventional to control temperatures in the de-staged (i.e. mains) fuel circuit to prevent coking due to heat pick up from the hot engine casing. One known approach, for example, is to provide a separate recirculation manifold which is used to keep the fuel in the mains manifold cool when it is deselected. It does this by keeping the fuel in the mains manifold moving, although a cooling flow also has to be maintained in the recirculation manifold during mains operation to avoid coking.

FIG. 1 shows schematically a combustion staging system 130 for a gas turbine engine. A metered fuel flow arrives at the staging system at a pressure P_{fmu}. The staging system splits the fuel into two flows: one at a pressure Pₚ for first 131a and second 131b segments of a pilot manifold and the other at a pressure Pₘ for a mains manifold 132. Fuel injectors 133 of a combustor of the engine are split into two groups. The injectors of one group are connected to the first pilot manifold segment 131a, while the injectors of the other group are connected to the second pilot manifold segment 131b. The mains manifold feeds secondary discharge orifices of the fuel injectors. Pilot FSVs 139 and mains FSVs 140 at the injectors prevent fuel flow into the injectors when the pressure difference between the upstream manifold and the downstream combustion chamber is below the cracking point of the valve (i.e. at conditions where the mains is de-staged and at shut down). The FSVs also prevent combustion chamber gases entering the respective manifolds if the downstream pressure exceeds a manifold pressure. By varying the fuel split between the manifolds, staging control of the engine can be performed.

In more detail, the staging system 130 has a fuel flow splitting valve (FFSV) 134, which receives the metered fuel flow from a hydromechanical unit (HMU) at pressure P_{fmu}. A spool is slidable within the FFSV under the control of a servo-valve 135, the position of the spool determining the outgoing flow split between a pilot connection pipe 136 which delivers fuel to the pilot manifold segments 131a, b and a mains connection pipe 137 which delivers fuel to the mains manifold 132. The spool can be positioned so that the mains stage is deselected, with the entire metered flow going to the pilot stage. A position sensor 138 provides feedback on the position of the spool to an engine electronic controller (EEC), which in turn controls staging by control of the servo-valve.

Between the FFSV 134 and the second pilot manifold segment 131b, the pilot connection pipe 136 communicates with a lean blow out protection valve 150 which controls communication between the pilot connection pipe 136 and the second pilot manifold segment 131b. The lean blow out protection valve is spring biased towards an open position. A solenoid operated control valve 152 is operable to apply a control pressure to the valve member of the lean blow out protection valve to move it against the action of the spring so that the valve is biased to a closed position, restricting the communication between the pilot connection pipe 136 and the second pilot manifold segment 131b, when required. Accordingly, if there is only a pilot delivery of fuel to the engine and there is a concern that a lean blow out condition may occur, the lean blow out protection valve 150 can be closed by appropriate control of the solenoid operated control valve 152, with the result that fuel delivery to the second pilot manifold segment 131b is restricted, whilst that to the first pilot manifold segment 131a is increased. Adequate pilot delivery through the reduced number of injectors fed by manifold segment 131a can therefore be assured, resulting in a reduced risk of a lean blow-out condition occurring.

The staging system 130 also has a recirculation line to provide the mains manifold 132 with a cooling flow of fuel when the mains manifold is deselected. The recirculation line has a delivery section including a delivery pipe 141 which receives the cooling flow from a fuel recirculating control valve (FRCV) 142, and a recirculation manifold 143 into which the delivery pipe feeds the cooling flow. The recirculation manifold has feeds which introduce the cooling flow from the recirculation manifold to the mains manifold via connections to the feeds from the mains manifold to the mains FSVs 140.

In addition, the recirculation line has a return section which collects the returning cooling flow from the mains manifold 132. The return section is formed by a portion of the mains connection pipe 137 and a branch pipe 144 from the mains connection pipe, the branch pipe extending to a recirculating flow return valve (RFRV) 145 from whence the cooling flow exits the recirculation line.

The cooling flow for the recirculation line is obtained from the HMU at a pressure HP_{f} via a cooling flow orifice (CFO) 146. On leaving the RFRV 145 via a pressure raising orifice (PRO) 147, the cooling flow is returned to the pumping unit for re-pressurisation by the HP pumping stage. A check valve 148 accommodates expansion of fuel trapped in the pilot and mains system during shutdown when the fuel expands due to combustor casing heat soak back. The check valve can be set to a pressure which prevents fuel boiling in the manifolds. The FRCV 142 and the RFRV 145 are operated under the control of the EEC. The HMU also supplies fuel at pressure HP_{f} for operation of the servo-valve 135, the RFRV 145, and the lean blow out protection valve 150.

When mains is staged in, a cooling flow is also directed through the recirculation manifold 143 to avoid coking therein. More particularly a small bypass flow is extracted from the HMU's metered fuel flow at pressure P_{fmu}. The bypass flow is sent via a flow washed filter 149 to a separate inlet of the FRCV 142, and thence through the delivery pipe 141 to the recirculation manifold 143. The bypass flow exits the recirculation manifold to rejoin the mains fuel flow at the injectors 133.

However, a problem with such a system is how to accommodate a mains FSV 140 failing to an open condition. In pilot-only operation, when cooling flow is passing through the recirculation manifold 143 and the mains manifold 132, such a failure can result in the cooling flow passing through the failed open FSV through one injector into the combustors, causing a hot streak which may lead to nozzle and turbine damage. In pilot and mains operation, such a failure can produce a drop in mains manifold pressure which causes other mains FSVs to close. A possible outcome is again that a high proportion of the total mains flow passes through the failed open FSV to one injector, causing a hot streak leading to nozzle and turbine damage.

In principle, such failure modes can be detected by appropriate thermocouple arrangements, e.g. to detect hot streaks. However, temperature measurement devices of this type can themselves have reliability issues.

Further, the problem of mains FSV failure can be exacerbated by system arrangements used to prevent combustion chamber gas ingress through the fuel injectors 133 during pilot only operation. Whilst the impact of such gas ingress is generally non-hazardous, it can lead to hot gas-induced degradation of FSV seals. Degraded FSV sealing can in turn lead to dribbling of fuel into de-staged nozzles, resulting in component blockage due to coking. For example, the system may be modified to make orifice 147 variable under servo-valve control so that the deselected mains manifold pressure can be controlled to maintain it at a level below that required to crack open the mains FSVs 140 but above combustion chamber pressure in order to prevent ingestion of hot combustion chamber gases past the FSV seals. A disadvantage of such an arrangement is that in the event of a mains FSV 140 failing open, the system may try to maintain manifold pressure above combustion chamber gas pressure (which can be taken to be approximately the same as the measured engine parameter P30—the high pressure compressor outlet pressure), and thus may react by delivering more flow to the fuel injectors. This further increases the risk of reducing nozzle and turbine life.

### SUMMARY

It would be desirable to address these problems.

Accordingly, in a first aspect, the present invention provides a fuel supply system for fuel injectors of a multi-stage combustor of a gas turbine engine, the fuel supply system including:
a metering and splitting arrangement which receives a total fuel flow and controllably meters and splits the received total fuel flow into metered pilot and mains flows for injecting respectively at pilot and mains fuel discharge orifices of the injectors to perform staging control of the combustor; and
pilot and mains fuel distribution pipeworks respectively distributing fuel from the metering and splitting arrangement to the pilot and mains discharge orifices;
wherein the metering and splitting arrangement is operable to select the pilot distribution pipework and deselect the mains distribution pipework for pilot-only operation in which there is a pilot supply to the combustor but no mains supply to the combustor from the injectors, and is operable to select both the pilot and mains distribution pipeworks for pilot and mains operation in which there are pilot and mains supplies to the combustor from the injectors;
wherein the fuel supply system further includes plural mains isolation valves and the mains fuel distribution pipework has plural fuel lines each of which is fluidly connected to a respective one of the mains fuel discharge orifices and extends therefrom to a respective one of the isolation valves;
wherein each isolation valve has a closed position in which it removes the mains fuel from its injector through its fuel line when the mains distribution pipework is deselected for pilot-only operation, and fluidly isolates its fuel line from the metering and splitting arrangement; and
wherein each isolation valve has an open position in which it refills its injector with mains fuel through its fuel line when the mains distribution pipework is selected for pilot and mains operation, and reconnects its fuel line to the metering and splitting arrangement.

Thus in contrast to the system shown in FIG. 1, by de-priming the mains path in the injectors (removing mains fuel) when mains is de-staged and re-priming the mains path in the injectors (refilling with mains fuel) when mains is staged in, and by isolating the fuel lines from the metering and splitting arrangement, it becomes possible to perform staging control of a multi-stage combustor without a recirculating cooling flow to a mains manifold during pilot-only operation and without fuel scheduling valves in the mains fuel passages of the injectors. Thus many of the problems indicated above can be avoided whilst enabling a simplified system (e.g. by removing mains FSVs and cooling recirculation architecture) with associated mass, cost and reliability benefits.

Moreover, having an isolation valve for each injector enables a high degree of control over the mains fuel removal and refilling.

The system also allows the injectors to have no pilot FSVs. These are not needed as the pilot supply flows continuously from the pilot fuel discharge orifices during normal operation, and can be reverse purged at shut down to prevent any leakage into the injectors and combustor. The reverse purge can be achieved, for example, by providing a manifold drain valve under the action of combustion chamber gas pressure. Removal of the pilot FSVs is a further simplification with cost, mass and reliability benefits. It also eliminates any potentially hazardous failure modes associated with flow maldistribution and subsequent turbine torching which can occur as a result of a pilot FSV seizing in an open position.

In a second aspect, the present invention provides a gas turbine engine having a multi-stage combustor and the fuel supply system according to the first aspect for supplying fuel to and performing staging control in respect of pilot and mains fuel discharge orifices of fuel injectors of the combustor.

The gas turbine engine may further have a pumping unit to supply the fuel flow to the metering and splitting arrangement of the fuel supply system.

The fuel injectors may be without fuel scheduling valves in respect of their mains discharge orifices. Each fuel injector may, however, have a respective weight distribution valve for its mains discharge orifice. The weight distribution valves can help to eliminate gravitational head effects between the injectors.

Optional features of the invention will now be set out. These are applicable singly or in any combination with any aspect of the invention.

Typically, the closed position of each isolation valve also fluidly isolates its fuel line from the other fuel lines. In this way leakage between fuel lines can be avoided and the system can be enabled to perform partial (e.g. circumferential) mains staging in which not all of the mains discharge orifices are switched on.

The pilot fuel distribution pipework may include a pilot fuel manifold distributing fuel from the metering and splitting arrangement to the pilot discharge orifices. The pilot manifold may include a segment restrictable by a lean blow out protection valve to decrease the proportion of the pilot fuel flow delivered to the injectors fed by the segment relative to the pilot fuel flow delivered to the remaining injectors of the combustor.

The metering and splitting arrangement may typically include: a metering valve (for example housed in an HMU) which receives and controllably meters the total fuel flow, and a splitting unit which receives the total metered flow from the metering valve and controllably splits the total metered flow into the pilot and mains flows. For example, the splitting sub-arrangement can be a fuel flow splitting valve or a set of valves providing a splitting function. As another example, the splitting sub-arrangement can be: a secondary metering valve, a fuel line extending between the secondary metering valve and a first one of the pilot and mains fuel distribution pipeworks, and a spill valve which is operable to control a pressure drop across the secondary metering valve by diverting a controlled portion of the total metered flow in the fuel line to the other of the pilot and mains fuel distribution pipeworks. In the case that the fuel line extends between the secondary metering valve and the pilot fuel distribution pipework, the diverted controlled portion forms the mains flow. More particularly, by controlling the secondary metering valve pressure drop and valve position (e.g. under closed loop control achieved via a servo-valve and position sensor), it is possible to set a pilot flow, the mains flow being the difference between total metered flow and pilot metered flow. In the case that the fuel line extends between the metering valve and the mains fuel distribution pipework, the diverted controlled portion forms the pilot flow. Another option, however, is for the metering and splitting arrangement to include: a pilot metering valve which receives and controllably meters a portion of the fuel flow for onward flow to the pilot distribution pipework, and a mains metering valve in parallel to the pilot metering valve, the mains metering valve receiving and controllably metering a different portion of the fuel flow for onward flow to the mains distribution pipework, wherein the relative values of the fuel flows controllably metered by the pilot and mains metering valves determine the staging control split of the pilot and mains flows. The pilot and mains metering valves can be in a single HMU or separate HMUs.

A pumping unit which supplies the fuel flow to the metering and splitting arrangement of the fuel supply system may have a low pressure pumping stage and high pressure pumping stage arranged in flow series. The low pressure pumping stage can be centrifugal pump, and the high pressure pumping stage can be a positive displacement pump (e.g. one more gear pumps). However, when the metering and splitting arrangement includes a mains metering valve in parallel to a pilot metering valve, the pumping unit may have dedicated and respective high pressure pumping stages for these two metering valves.

The fuel supply system may further have a controller to control the metering and splitting arrangement and the isolation valves. For example, the controller can be an element of an engine electronic controller (EEC). The controller may be configured to perform refilling through the fuel lines at different times and/or different rates for different fuel lines. This can help to reduce dips and spikes during mains fuel staging.

Each isolation valve in its closed position may also remove mains fuel from a portion of its fuel line adjacent its injector, and in its open position refill said portion of its fuel line with mains fuel. For example, each isolation valve may remove fuel from substantially the entirety of its fuel line when the mains distribution pipework is deselected for pilot-only operation, and may refill its fuel line when the mains distribution pipework is selected for pilot and mains operation. Typically the more fuel is removed, the longer time is required for refilling. However, in general, enough fuel should be removed so as to effectively remove a risk of fuel egress into the injectors, causing coking.

Each fuel line may have a top portion at an end thereof and a bottom portion at an opposite end thereof, and be routed such that its injector is at the top end and its isolation valve is at the bottom end. In this way, if the fuel line is not fully emptied, fuel should not egress into its fuel injectors.

Conveniently, each isolation valve may have: a valve housing which forms an inlet to the mains distribution pipework between the isolation valve and the metering and splitting arrangement, and which forms an outlet to the fuel line of the isolation valve; and a piston which is slidably movable in the housing between first and second end positions which respectively correspond to the closed and open positions of the valve. The housing and the piston can then be configured such that in the second end position of the piston the inlet and the outlet fluidly communicate with each other, and such that in the first end position of the piston a fluid tight seal is formed between the inlet and the outlet.

In particular, in such an arrangement each isolation valve may have a variable volume, fuel storage sink which is in fluid communication with the outlet, the volume of the sink being at its greatest when the piston is in its first end position, and being at its smallest when the piston is in its second end position. The housing and the piston can then be configured such that, at an intermediate position of the piston, the inlet is substantially closed off by the piston, whereby on moving from its intermediate position to its first end position, the piston draws mains fuel in the fuel line into the sink through the outlet, thereby removing the mains fuel from the injector, and whereby on moving from its first end position to its intermediate position, the piston pushes fuel stored in the sink into the fuel line through the outlet, thereby refilling the injector with mains fuel. Such an arrangement can help to increase the speed and accuracy of the re-priming.

The piston of each isolation valve may be spring biased towards its first end position. Thus in the unlikely event of a control failure of the valve, it can default to a safe closed position.

The isolation valves can be pneumatically, hydraulically (e.g. fuel-draulically), mechanically, electrically or electro-mechanically controlled. An electro-mechanical actuator may be a rotary to linear actuator (such as a motor and ball screw actuator or a motor and rack and pinion actuator) or a linear to linear actuator. For example, a respective electro-mechanical actuator may control each valve. As another example, when the piston of each isolation valve is spring biased towards its first end position, the valve may have a servo chamber for receipt of hydraulic control fluid such that increasing the fluid pressure in the servo chamber urges the piston towards its second end position in opposition to the spring bias. When the movements of the pistons of the isolation valves are hydraulically controlled, the fuel supply system typically further includes a solenoid or servo valve which sets the hydraulic fluid control pressure. One option is for a single solenoid or servo valve to set the fuel pressure for all of the isolation valves. However, another option is for subsets of the isolation valves to have respective solenoid valve or servo valves to set the respective fuel pressures of the different subsets. This can facilitate partial mains staging. Preferably, the movement of the piston of each isolation valve is hydraulically controlled by fuel pressure.

Each fuel line may include a respective pressure and/or flow sensor which issues a signal when its injector is refilled. The signals can be used to control the order of injector refilling. However, more generally the signals allows refilling failure to be monitored.

### BRIEF DESCRIPTION OF THE DRAWINGS

Embodiments of the invention will now be described by way of example with reference to the accompanying drawings in which:

FIG. 1 shows schematically a combustion staging system for a gas turbine engine in pilot and mains operation mode;

FIG. 2 shows a longitudinal cross-section through a ducted fan gas turbine engine;

FIG. 3 shows schematically a fuel supply system for fuel injectors of a multi-stage combustor of the gas turbine engine;

FIG. 4 shows stages in the operation of an isolation valve of the fuel supply system of FIG. 3;

FIG. 5 shows schematically a variant e supply system for fuel injectors of the multi-stage combustor; and

FIG. 6 shows schematically a further variant fuel supply system for fuel injectors of the multi-stage combustor.

### DETAILED DESCRIPTION AND FEATURES

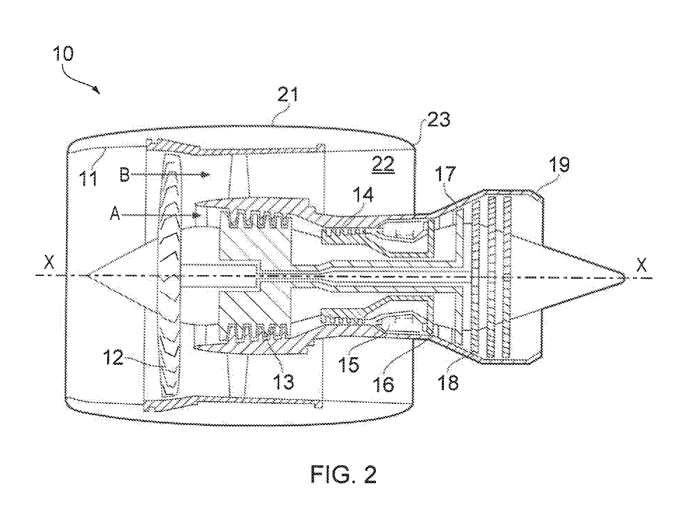

With reference to FIG. 2, a ducted fan gas turbine engine incorporating the invention is generally indicated at 10 and has a principal and rotational axis X-X. The engine comprises, in axial flow series, an air intake 11, a propulsive fan 12, an intermediate pressure compressor 13, a high-pressure compressor 14, combustion equipment 15, a high-pressure turbine 16, an intermediate pressure turbine 17, a low-pressure turbine 18 and a core engine exhaust nozzle 19. A nacelle 21 generally surrounds the engine 10 and defines the intake 11, a bypass duct 22 and a bypass exhaust nozzle 23.

During operation, air entering the intake 11 is accelerated by the fan 12 to produce two air flows: a first air flow A into the intermediate-pressure compressor 13 and a second air flow B which passes through the bypass duct 22 to provide propulsive thrust. The intermediate-pressure compressor 13 compresses the air flow A directed into it before delivering that air to the high-pressure compressor 14 where further compression takes place.

The compressed air exhausted from the high-pressure compressor 14 is directed into the combustion equipment 15 where it is mixed with fuel and the mixture combusted. The resultant hot combustion products then expand through, and thereby drive the high, intermediate and low-pressure turbines 16, 17, 18 before being exhausted through the nozzle 19 to provide additional propulsive thrust. The high, intermediate and low-pressure turbines respectively drive the high and intermediate-pressure compressors 14, 13 and the fan 12 by suitable interconnecting shafts.

The engine has a pump system comprising typically a low pressure (LP) pumping stage which draws fuel from a fuel tank of the aircraft and supplies the fuel at boosted pressure to the inlet of a high pressure (HP) pumping stage. The LP stage typically comprises a centrifugal impeller pump while the HP pumping stage may comprise one or more positive displacement pumps, e.g. in the form of twin pinion gear pumps. The LP and HP stages are typically connected to a common drive input, which is driven by the engine HP or IP shaft via an engine accessory gearbox.

The combustion equipment 15 of the engine 10 includes a multi-stage combustor. A fuel supply system accepts fuel from the HP pumping stage for feeding to the combustor. This system typically has a hydro-mechanical unit (HMU) which performs total metering and comprises a fuel metering valve operable to control the rate at which fuel is allowed to flow to the combustor. The HMU further typically comprises: a pressure drop control arrangement (such as a spill valve and a pressure drop control valve) which is operable to maintain a substantially constant pressure drop across the metering valve, and a pressure raising and shut-off valve at the fuel exit of the HMU which ensures that a predetermined minimum pressure level is maintained upstream thereof for correct operation of any fuel pressure operated auxiliary devices (such as variable inlet guide vane or variable stator vane actuators) that receive fuel under pressure from the HMU. Further details of such an HMU are described in EP 2339147 A (hereby incorporated by reference).

An engine electronic controller (EEC) commands the HMU fuel metering valve to supply fuel to the combustor at a given flow rate. The metered fuel flow leaves the HMU and arrives at a staging system 30 of the fuel supply system.

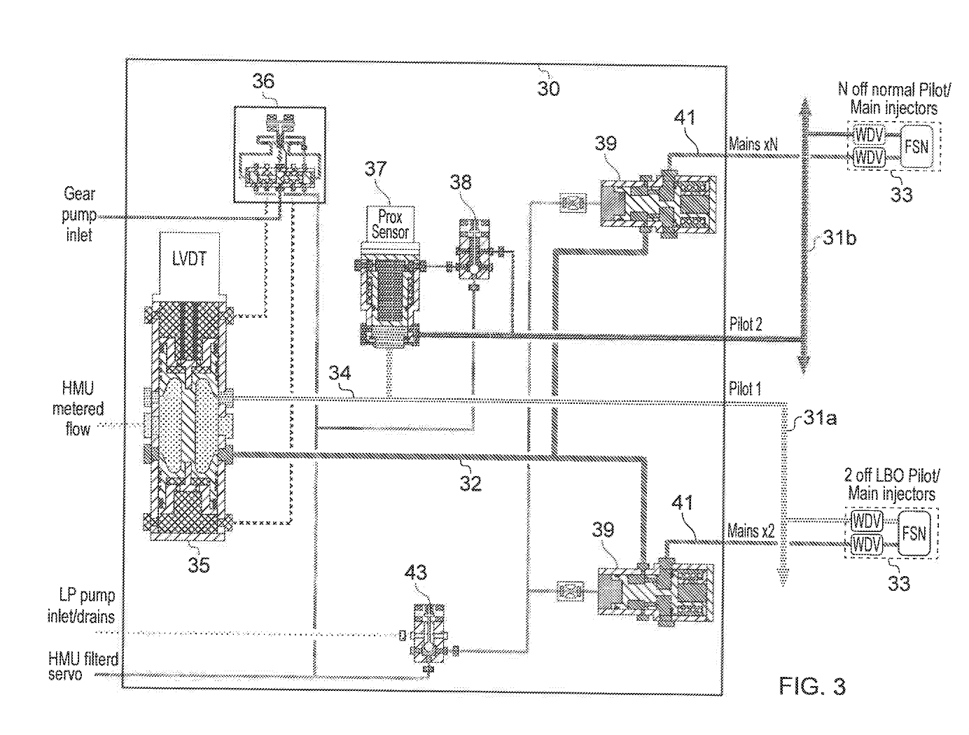

The staging system 30 splits the fuel into two flows: one for a pilot flow along pilot fuel distribution pipework 34 to first 31a and second 31b segments of a pilot manifold and the other for a mains flow along mains fuel distribution pipework 32. Fuel injectors 33 (only two being shown in FIG. 3) of a combustor of the engine are split into two groups. Pilot (primary) discharge orifices of the fuel spray nozzles (FSNs) of the injectors of one group are connected to the first pilot manifold segment 31a, while pilot discharge orifices of the FSNs of the injectors of the other group are connected to the second pilot manifold segment 31b. The mains flow feeds mains (secondary) discharge orifices of the FSNs of the fuel injectors. The pilot and mains discharge orifices have respective weight distribution valves (WDVs) to reduce gravitational head effects between the injectors.

A fuel flow splitting valve (FFSV) 35 receives the metered fuel flow from the HMU. Typically, the FFSV has a slidable spool under the control of a servo-valve 36, the position of the spool determining the outgoing flow split between two outlets forming respectively the pilot flow and the mains flow. The spool can be positioned so that the mains stage is completely deselected, with the entire metered flow going to the pilot stage. An LVDT can provide feedback on the position of the spool to the EEC, which in turn controls staging by control of the servo-valve.

The pilot fuel distribution pipework 34 splits the pilot flow between the first 31a and second 31b segments of the pilot manifold. A lean blow out protection valve 37 and a solenoid-operated control valve 38 may be located between the pilot fuel distribution pipework and the second pilot manifold segment 31b.

The mains fuel distribution pipework 32 splits the mains flow into sub-flows, one for each injector 33. More particularly, each sub-flow is directed to a respective isolation valve 39 and then through a respective fuel line 41 which extends to the given injector. The isolation valves perform de-prime and re-prime (discussed in more detail below) and isolation functions on their injectors. Each fuel line 41 can be routed vertically with its fuel injector 33 at the top and its isolation valve 39 at the bottom. This helps to ensure that, if the fuel line is not fully emptied, then fuel does not egress into the fuel injectors, causing coking of the injector nozzle.

The isolation function, as well as assisting with injector de-priming and re-priming, allows the isolation valves 39 to controllably isolate their injectors from the mains flow from the FFSV 35, so that the EEC can perform partial mains staging. Typically this involves staging in a subset of the injectors, the injectors of the subset being equally circumferentially spaced around the combustor.

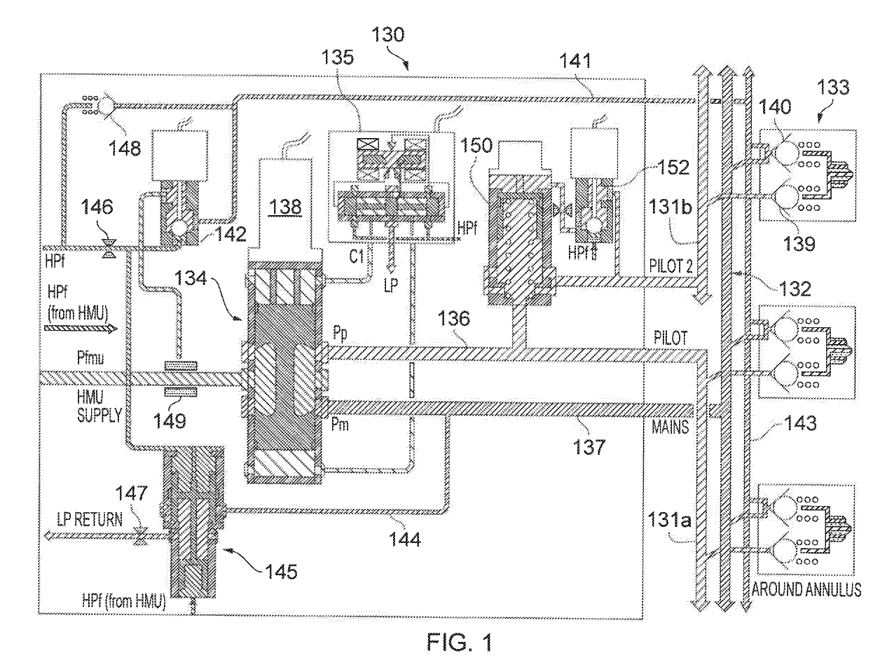

The fuel supply system aims to improve on combustion staging systems of the type shown in FIG. 1 by removing a requirement for individual check valves (mains FSVs) at the mains injector heads. As discussed above, FSVs can inadvertently cause injector-to-injector fuel flow variation, which can potentially reduce the life of the combustor and turbine gas path components. The staging system 30 removes the requirement for such valves by de-priming the mains fuel passages of the injectors 33 (and preferably also the fuel lines 41) when the mains flame is staged-out, and then re-priming the mains fuel passages of the injectors (and the fuel lines if necessary) prior to the mains flame being staged back in.

In particular, the isolation valves 39 have a closed position for pilot-only operation in which the valves remove (de-prime) the mains fuel from their injector 33 through their fuel lines 41, and fluidly isolate their fuel line from the FFSV 35, and an open position for pilot and mains operation in which the valves refill (re-prime) their injectors with mains fuel through their fuel lines, and reconnect their fuel lines to the FFSV. The positional state of the isolation valves 39 is determined by an isolation control valve 43, which in turn is controlled by the EEC. The isolation control valve can be, for example, a solenoid valve, as shown, or a servo valve.

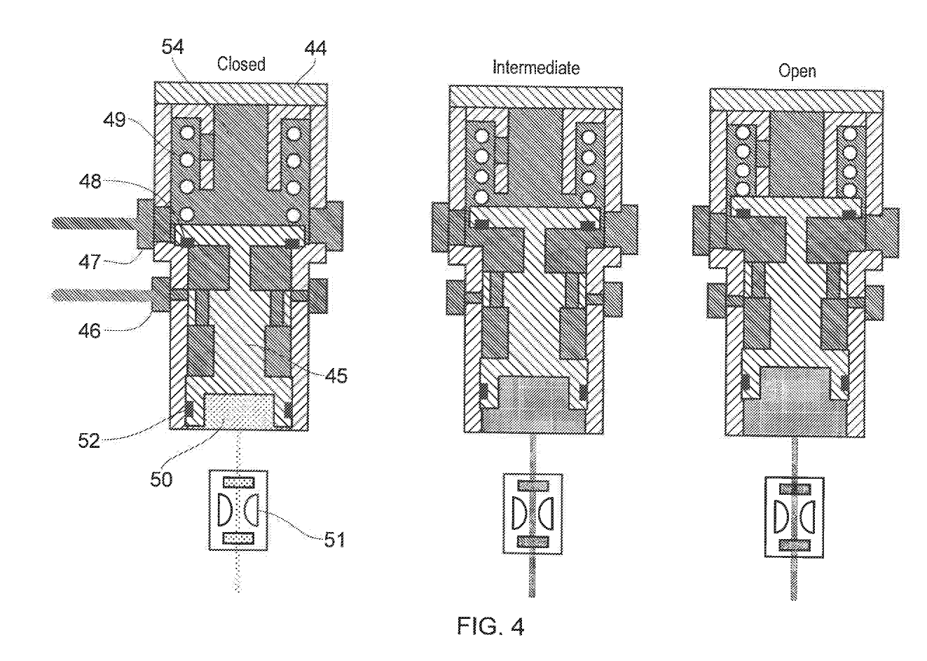

As shown in FIG. 4, each isolation valve 39 has a housing 44 and a piston 45 which is slidably movable in the housing. More particularly, FIG. 4 shows at left the piston in a first end position corresponding to the closed position of the valve, at right the piston in a second end position corresponding to the open position of the valve, and at centre the piston in an intermediate position between the two end positions. The housing defines an inlet 46 to the mains distribution pipework 32 between the isolation valve and the FFSV 35, and an outlet 47 to the valve's fuel line 41. In the first end (closed) position of the piston, a drip tight seal carried by the piston engages with housing to seal off the inlet from the outlet, and thereby isolate the fuel line from the FFSV, and indeed the fuel line 41 from the other fuel lines 41. In contrast, in the second end (open) position of the piston, the inlet and the outlet are able to fluidly communicate, reconnecting the fuel line 41 to the FFSV.

A spring 49 at one end of the piston 45 biases the piston towards the closed position. The isolation control valve 43 ports either high pressure or low pressure fuel to a servo chamber 50 at the other end of the piston 45. In the case of high pressure being ported to the servo chamber, the spring bias is overcome, allowing the isolation valve 39 to open. Conversely, porting low pressure to the servo chamber allows the spring bias to close the isolation valve. Each isolation valve 39 can have a restriction orifice 51 in the line between its servo chamber and the isolation control valve 43. These orifices improve the distribution of flow between the isolation valves to ensure that they move more synchronously. A dynamic seal 52 on the piston 45 can isolate the servo chamber pressure from the mains sub-flow delivered to the injector 33 through the isolation valve.

When moving each isolation valve 39 from its open position to its closed position to de-stage mains, the piston 45 has to first pass through its intermediate position. The piston and housing 44 are configured such that in this position a portion of the piston blocks the inlet 46. Consequently, subsequent movement of the piston towards its dosed position draws fuel from the fuel line 41 into a sink 54 formed in the housing and having a variable volume determined by the position the piston. In doing so, the isolation valve empties its injector of mains fuel, stopping fuel delivery to the combustion zone from the mains discharge orifice and stopping fuel from dribbling into the FSN where it can degrade and block the nozzles.

Conversely, when moving each isolation valve 39 from its closed position to its open position to stage in mains, the piston 45 has to move to its intermediate position before the inlet 46 becomes unblocked. This initial movement reduces the volume of the sink 54, thereby pushing fuel stored in the sink back into the fuel line 41 to refill the injector 33 with mains fuel.

The combination of piston stroke and diameter determines the volume of fuel withdrawn and pushed back into the fuel line 41, and a combination of the characteristics of the isolation control valve 43 and the restriction orifice 51 provide control of the piston's slew velocity. Sufficient volume should be withdrawn from the fuel line 41 to ensure that no mains fuel is delivered to the mains discharge orifice of the FSN during aircraft manoeuvres or when any fuel remaining in the fuel line 41 expands due to temperature increases. Thus in general, as well as withdrawing a volume which is enough to empty the injector 33 of mains fuel, typically also a further volume is withdrawn to remove mains fuel from at least that part of the fuel line 41 closest to the injector.

Advantageously, providing each isolation valve 39 with its own sink 54 can reduce the time needed to refill in re-priming, and also helps to avoid under- and over-fuelling the pilot and mains flames respectively.

In order that the bulk of the volume displaced by the isolation valve 39 is into and out of the fuel line 41, the stroke of the piston between the intermediate and open positions can be reduced. To achieve this, the inlet 46 can combine a short axial length with a large circumferential width to provide an acceptably low pressure loss when a maximum mains sub-flow is passing through the isolation valve.

When mains is staged out, any fuel remaining in the fuel lines 41 is stagnant and may require thermal management (e.g. by external air flow) to keep its temperature below an acceptable level.

As mentioned above, the fuel supply system permits the removal of mains FSVs and hence mitigates associated issues/risks (e.g. mal-scheduling due to a failed open FSV; nozzle-to-nozzle fuel distribution variation due to FSV-to-FSV component variation; and lifing issues such as seal wear/degradation leading to fuel dribbling and consequent nozzle coking).

However, a further advantage of the fuel supply system is that it can enable individual flow stream control for re-prime and subsequent staging, which can help to reduce/eliminate transient dips in pilots flow. It also allows valves to be moved away from the burner head into a more benign environment, providing for improved control of component temperatures, which in turn reduces the risk of degradation in component/system performance due to fuel coking.

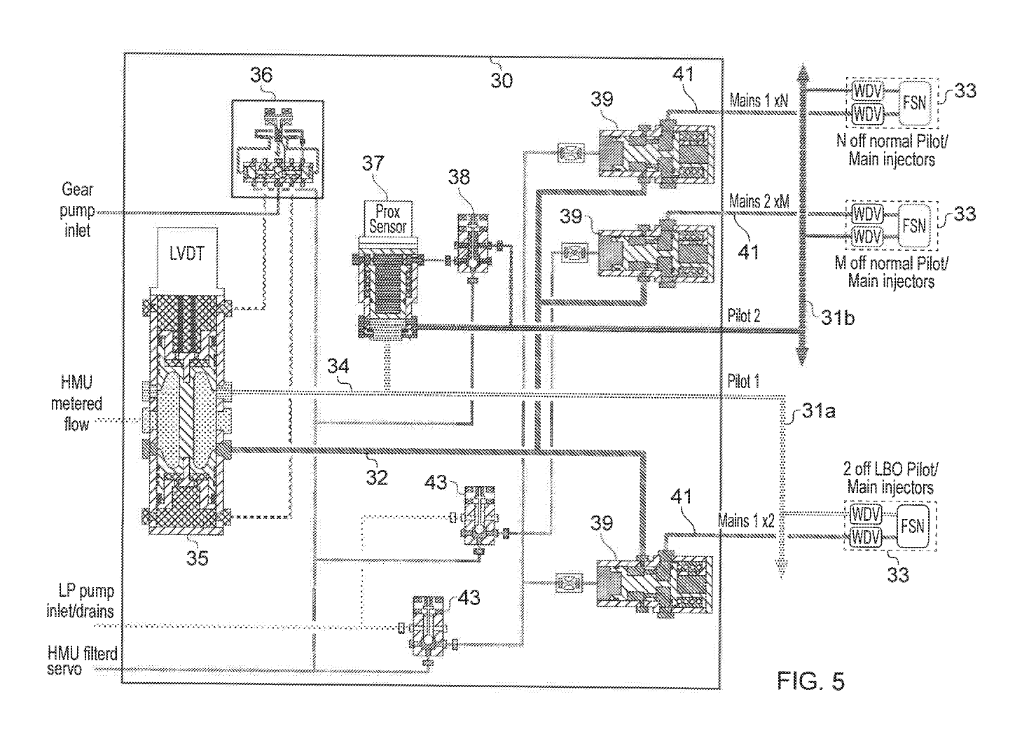

FIG. 5 shows schematically a variant of the fuel supply system. In the variant a first subset of the isolation valves 39 is controlled by one isolation control valve 43, and a second subset of the isolation valves 39 is controlled by a second isolation control valve 43. This allows the mains sub-flow delivered to each injector 33 in one subset for a given total mains flow to be increased by staging out mains for the injectors of the other subset. This is advantageous as FSNs generally have a minimum required level of mains flow for satisfactory operation.

As the number of such isolation control valves 43 is increased the possibility for individual flow stream control is enhanced.

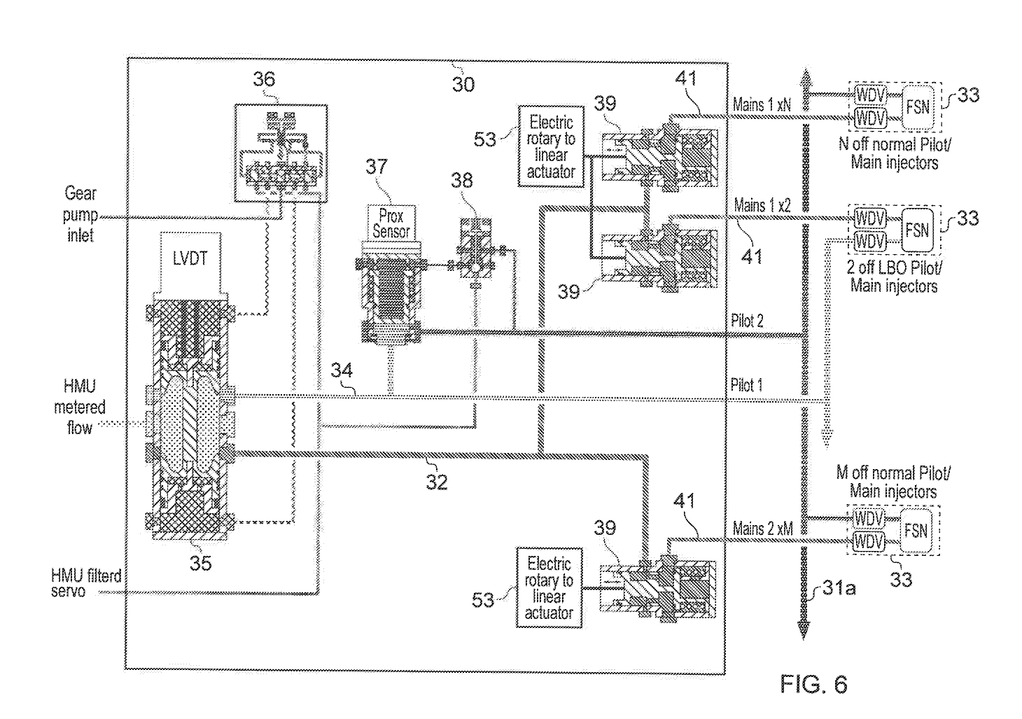

FIG. 6 shows schematically a further variant of the fuel supply system. In the further variant, each isolation valve 39 is operated by an electro-mechanical device 53, such as an electric motor and ball screw actuator, rather than a hydraulic or electro-hydraulic device.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

What is claimed is:

1. A fuel supply system for fuel injectors of a multi-stage combustor of a gas turbine engine, the fuel supply system including:
a metering and splitting arrangement which receives a fuel flow and controllably meters and splits the received fuel flow into metered pilot and mains flows for injecting respectively at pilot and mains fuel discharge orifices of the injectors to perform staging control of the combustor; and
pilot and mains fuel distribution pipeworks respectively distributing fuel from the metering and splitting arrangement to the pilot and mains discharge orifices;
wherein the metering and splitting arrangement is operable to select the pilot distribution pipework and deselect the mains distribution pipework for pilot-only operation in which there is a pilot supply to the combustor but no mains supply to the combustor from the injectors, and is operable to select both the pilot and mains distribution pipeworks for pilot and mains operation in which there are pilot and mains supplies to the combustor from the injectors;
wherein the fuel supply system further includes plural mains isolation valves and the mains fuel distribution pipework has plural fuel lines each of which is fluidly connected to a respective one of the mains fuel discharge orifices and extends therefrom to a respective one of the isolation valves;
wherein each isolation valve has a closed position in which it removes the mains fuel from its injector through its fuel line when the mains distribution pipework is deselected for pilot-only operation, and fluidly isolates its fuel line from the metering and splitting arrangement; and
wherein each isolation valve has an open position in which it refills its injector with mains fuel through its fuel line when the mains distribution pipework is selected for pilot and mains operation, and reconnects its fuel line to the metering and splitting arrangement.

2. A fuel supply system according to claim 1, wherein the pilot fuel distribution pipework includes a pilot fuel manifold distributing fuel from the metering and splitting arrangement to the pilot discharge orifices.

3. A fuel supply system according to claim 1, wherein the metering and splitting arrangement includes: a metering valve which receives and controllably meters the fuel flow, and a splitting unit which receives the metered flow from the metering valve and controllably splits the metered flow into the pilot and mains flows.

4. A fuel supply system according to claim 1, wherein each isolation valve in its closed position also removes mains fuel from a portion of its fuel line adjacent its injector, and in its open position refills said portion of its fuel line with mains fuel.

5. A fuel supply system according to claim 1, wherein each fuel line has a top portion at an end thereof and a bottom portion at an opposite end thereof, and is routed such that its injector is at the top end and its isolation valve is at the bottom end.

6. A fuel supply system according to claim 1, wherein each isolation valve has:
a valve housing which forms an inlet to the mains distribution pipework between the isolation valve and the metering and splitting arrangement, and which forms an outlet to the fuel line of the isolation valve; and
a piston which is slidably movable in the housing between first and second end positions which respectively correspond to the closed and open positions of the valve;
wherein the housing and the piston are configured such that in the second end position of the piston the inlet and the outlet fluidly communicate with each other, and such that in the first end position of the piston a fluid tight seal is formed between the inlet and the outlet.

7. A fuel supply system according to claim 6, wherein:
each isolation valve has a variable volume, fuel storage sink which is in fluid communication with the outlet, the volume of the sink being at its greatest when the piston is in its first end position, and being at its smallest when the piston is in its second end position; and
the housing and the piston are configured such that, at an intermediate position of the piston, the inlet is substantially closed off by the piston, whereby on moving from its intermediate position to its first end position, the piston draws mains fuel in the fuel line into the sink through the outlet, thereby removing the mains fuel from the injector, and whereby on moving from its first end position to its intermediate position, the piston pushes fuel stored in the sink into the fuel line through the outlet, thereby refilling the injector with mains fuel.

8. A fuel supply system according to claim 6, wherein the piston of each isolation valve is spring biased towards its first end position.

9. A fuel supply system according to claim 6, wherein the movements of the pistons of the isolation valves are hydraulically controlled, and the fuel supply system further includes a solenoid or servo valve which sets the hydraulic fluid control pressure.

10. A fuel supply system according to claim 6, wherein the movements of the pistons of the isolation valves are hydraulically controlled by fuel pressure,

11. A gas turbine engine having a multi-stage combustor and the fuel supply system according to claim 1 for supplying fuel to and performing staging control in respect of pilot and mains fuel discharge orifices of fuel injectors of the combustor.
